(19) United States
(12) Patent Application Publication
(10) Pub. No.: US 2005/0185063 A1
(43) Pub. Date: Aug. 25, 2005

(54) Digital camera

(75) Inventors: Tatsuhiko Ikehata, Tokyo (JP); Shiro Nagaoka, Tokyo (JP); Kei Tashiro, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/062,573

(22) Filed: Feb. 23, 2005

(30) Foreign Application Priority Data
Feb. 24, 2004 (JP) 2004/48187

(51) Int. Cl. H04N 5/228

(52) U.S. Cl. 348/222.1

(57) ABSTRACT

A digital camera comprises a photographing and display unit for performing digital signal processing on an image pick-up signal that is converted from an optical image, to generate a digital video signal, and for displaying an image based on the digital video signal, a user setting unit for setting identification information for identifying a plurality of users including an owner of the photographing and display unit, such as a character, symbol, voice and face video image, a using photographing-function setting unit for setting a photographing function used by every user, and a user determining unit for determining the user based on the identification information of the user and for enabling photographing the image by using the photographing function depending on the determining result.

### CROSS-REFERENCE TO RELATED APPLICATIONS

This application is based upon and claims the benefit of priority from the prior Japanese Application No. 2004-48187 filed in Japan on Feb. 24, 2004; the entire contents of which are incorporated herein by reference.

### BACKGROUND OF THE INVENTION

1. Field of the Invention

The present invention relates to a digital camera which can identify an owner of the digital camera, and can set a plurality of users including the owner and a photographing function by every user.

2. Description of the Related Art

A digital camera is put into practical use to photoelectrically converting an optical image of a subject with a solid-state image pick-up device, to generate an electric image-pick-up signal, to perform predetermined signal processing on the image pick-up signal for converting to digital video data, and to record the data to a recording medium.

In order to identify an owner of the digital camera, a sticker or tag on which an owner name is described is attached to the digital camera. The sticker or tag is easily detached. The digital camera from which the sticker or tag is detached disables the owner identification.

Then, Japanese Unexamined Patent Application Publication No. 2001-169163 discloses a digital camera which can identify an owner by a method except for the sticker or tag. The digital camera disclosed in Japanese Unexamined Patent Application Publication No. 2001-169163 first captures a video image of the owner of the digital camera, and automatically stores the captured video image of the owner as an ID video image to a memory dedicated to the ID. The ID video image stored in the memory dedicated to the ID is read from the memory dedicated to the ID every time the digital camera starts for photographing, and displays the video image of the owner on a display unit. As mentioned above, the owner of the digital camera is recognized.

However, the digital camera is not used only by the owner. For example, a family of the owner or a plurality of users such as a friend or a member of a group of the owner can use the digital camera.

In the digital camera, any user can view video data which is captured and is recorded, and can delete the video data.

The digital camera, in which the owner can be recognized by the ID video image stored in the memory dedicated to the ID, does not prohibit the photographing of any user except for the owner, and enables the photographing operation of a plurality of users. Therefore, there is a problem that the captured video data is erroneously erased by another user or another user freely views the video data which is not desired to be viewed by the other user.

### SUMMARY OF THE INVENTION

It is an object of the present invention to provide a digital camera which individually sets an owner of the digital camera and another user other than the owner, sets a function of a photographing operation of the digital camera every user including the owner, and prevents the viewing and erasure of the video data by another user except for the photographing person.

According to the present invention, a digital camera comprises: a photographing and display unit for performing digital signal processing on a photographing image signal that is generated by photographing a subject image, to generate a digital video signal, and for displaying an image based on the digital video signal; a user setting unit for setting identification information for identifying a plurality of users including an owner of the photographing and display unit; a using photographing-function setting unit for setting a photographing function of the photographing and display unit that permits the use by every user set by the user setting unit; and a user determining unit for determining the user based on the identification information of the user set by the user setting unit and for enabling photographing the image by using the photographing function set to the using photographing-function setting unit.

Further, according to the present invention, a digital camera comprises: a photographing and display unit for performing digital signal processing on a photographing image signal that is generated by photographing a subject image, to generate a digital video signal, and for displaying an image based on the digital video signal; a user setting unit for setting identification information for identifying a plurality of users including an owner of the photographing and display unit; a using photographing-function setting unit for setting a photographing function of the photographing and display unit that permits the use by every user set by the user setting unit; a user determining unit for determining the user based on the identification information of the user set by the user setting unit and for enabling photographing the image by using the photographing function set to the using photographing-function setting unit; and a restoring unit for restoring the state of the digital camera so as to use the photographing and display unit when the identification information of the user including the owner set to the user setting unit is lost and the photographing and display unit is not used.

The above and other objects, features and advantage of the invention will become more clearly understood from the following referring to the accompanying drawings.

### BRIEF DESCRIPTION OF THE DRAWINGS

FIG. 1 is a block diagram showing the structure of a digital camera according to an embodiment of the present invention;

FIG. 2 is a flowchart for explaining the operation of a user registering mode in the digital camera according to the embodiment of the present invention;

FIG. 3 is an explanatory diagram of an owner setting screen in the digital camera according to the embodiment of the present invention;

FIG. 4 is an explanatory diagram of a user setting screen in the digital camera according to the embodiment of the present invention;

FIG. 5 is an explanatory diagram of a screen for setting a function of a photographing operation for every user in the digital camera according to the embodiment of the present invention;

FIG. 6 is a flowchart for explaining the operation of a user confirming method in the digital camera according to the first embodiment of the present invention;

FIG. 7 is an explanatory diagram of a user selecting screen in the digital camera according to the embodiment of the present invention;

FIG. 8 is an explanatory diagram of a user character password log-in screen in the digital camera according to the embodiment of the present invention;

FIG. 9 is an explanatory diagram of the selection of a face video password from the password log-in screen in the digital camera according to the embodiment of the present invention;

FIG. 10 is an explanatory diagram of a user face photographing screen in the digital camera according to the embodiment of the present invention;

FIG. 11 is an explanatory diagram of user face photographing operation in the digital camera according to the embodiment of the present invention;

FIG. 12 is an explanatory diagram of voice password selection from the password log-in screen in the digital camera according to the embodiment of the present invention;

FIG. 13 is an explanatory diagram of a user voice screen in the digital camera according to the embodiment of the present invention;

FIG. 14 is an explanatory diagram of a user voice input in the digital camera according to the embodiment of the present invention;

FIG. 15 is an explanatory diagram of the selection of a figure password from the password log-in screen in the digital camera according to the embodiment of the present invention; and

FIG. 16 is an explanatory diagram of a user figure password input screen in the digital camera according to the embodiment of the present invention.

### DESCRIPTION OF THE PREFERRED EMBODIMENTS

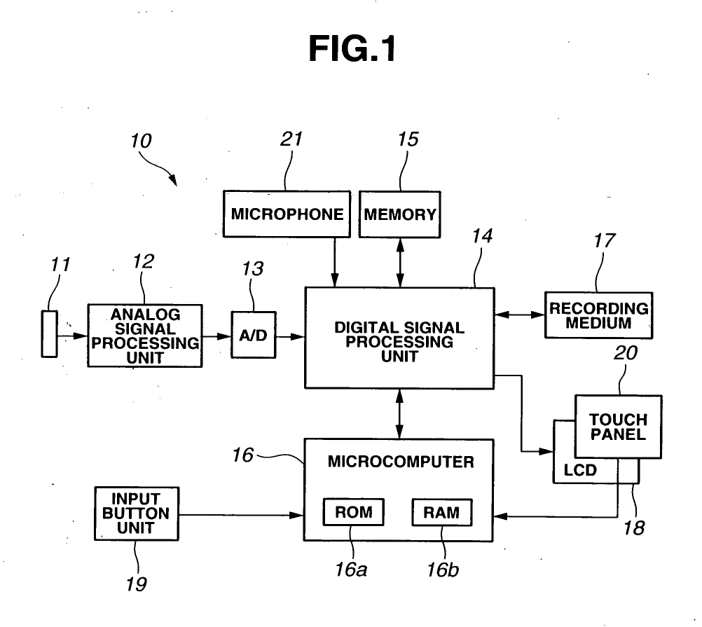

Hereinbelow, a description is given of the structure of a digital camera according to an embodiment of the present invention with reference to FIG. 1. According to the present invention, a digital camera (hereinafter, simply referred to as a camera) 10 comprises: an optical lens (not shown); a charge coupled-device (hereinafter, referred to as a CCD) 11; an analog signal processing unit 12; an analog/digital converter (hereinafter, referred to as an A/D converter) 13; a digital signal processing unit 14; a memory 15; a microcomputer 16; a recording medium 17; a liquid crystal display panel (hereinafter, referred to as an LCD) 18; an input button unit 19; a touch panel 20; and a microphone 21.

The CCD 11 forms an image of a subject through the optical lens, photoelectrically converts the subject image, and generates an analog electric signal.

The analog signal processing unit 12 amplifies and filters the waves of the analog electric signal generated by the CCD 11.

The A/D converter 13 converts the analog electric signal from the analog signal processing unit 12 into a digital signal.

The digital signal processing unit 14 performs predetermined digital signal processing of the digital signal from the A/D converter 13, and generates video data. In the digital signal processing, the still-image photographing operation uses JPEG system, and the moving-image photographing operation uses MPEG2 system for coding, thereby generating the compressed digital video data.

The memory 15 temporarily records the digital video data generated by the digital signal processing unit 14.

The microcomputer 16 controls the driving operation of the digital signal processing unit 14, and controls the photographing operation of the digital camera 10.

The recording medium 17 records the digital video data which is temporarily recorded in the memory 15 under the control of the microcomputer 16. The recording medium 17 is a recording medium such as a semiconductor memory, which is detachably attached to the camera 10 and to/from which the digital video data is written or is read.

The LCD 18 displays a photographing image based on the digital video data that is generated by the digital signal processing unit 14 and is temporarily recorded to the memory 15 and the digital video data recorded to the recording medium 17. Further, the LCD 18 displays a screen for selecting a photographing function of the camera 10, in addition to the photographing image of the digital video data recorded to the recording medium 17 and the memory 15.

The input button unit 19 includes an instructing button for measuring the distance to the subject and the brightness of the subject, a shutter button, a zoom button, a selecting button of various photographing modes, and a power button. Information on the button operated by the input button unit 19 is inputted to the microcomputer 16.

The touch panel 20 is arranged to an image display screen of the LCD 18. A user touches, via the touch panel 20, a screen for selecting the photographing function displayed on the LCD 18 and then the coordinate of the user touching position is detected. The microcomputer 16 determines the coordinate of the finger touching position detected by the touch panel 20 and the position of the selecting screen of the photographing function displayed on the LCD 18, and recognizes the photographing function selected by the user.

The microphone 21 inputs voice as a part of user identification information of the camera 10, which will be described later.

The microcomputer 16 comprises a ROM 16a which stores a program of various control modes for controlling the driving of the digital signal processing unit 14 and a program of user confirming processing and registering processing of the photographing function used by every user and registering processing of the user including the owner, which will be described later. Further, the microcomputer 16 comprises a RAM 16b which is used as a working area of the program read from the ROM 16a. In the microcomputer 16, the program is developed in accordance with the input operation using the input button unit 19 and the touch panel 20, and the driving of the digital signal processing unit 14 and the photographing function are controlled.

In the camera 10, the power button arranged to the input button unit 19 is turned on, the shutter button is operated, the CCD 11 as an image pick-up unit is driven, and the subject image is converted into the analog electric signal. The analog electric signal is amplified and is subjected to analog signal processing such as filtering processing by the analog signal processing unit 12 as a signal processing unit. Then, the A/D converter 13 converts the analog electric signal into the digital signal. Under the control of the microcomputer 16, the digital signal processing unit 14 encodes the digital signal of the still image in JPEG system and the digital signal of the moving image in MPEG2 system. Further, the digital signal is subjected to the digital signal processing such as compression and is converted into the digital video data. The digital video data is temporarily recorded to the memory 15 as a storing unit, and is read from the memory 15 based on the control of the microcomputer 16 and is recorded to the recording medium 17. Furthermore, the digital video data read from the memory 15 is decoded and decompressed, and is sent to the LCD 18 as a display unit, serving as a video signal. That is, the LCD 18 displays the still image or moving image which is picked-up and is subjected to the signal processing by the CCD 11, the analog signal processing unit 12, the A/D converter 13, and the digital signal processing unit 14. The still image or moving image is recorded to the recording medium 17, serving as the digital video data.

The camera 10 sets the registration of the owner of the camera 10 and the user except for the owner, further sets the registration of the photographing function which can be used by each of the user, and confirms the user when the user uses the camera 10.

The microcomputer 16 of the camera 10 stores a control program having a mode for setting the registration of the owner and the user except for the owner, a mode for setting the photographing function which can be used by each of the user, and a user registering mode. Further, the microcomputer 16 stores a control program of a user confirming mode for confirming whether or not the user has already been registered for user, upon using the camera 10 for photographing operation.

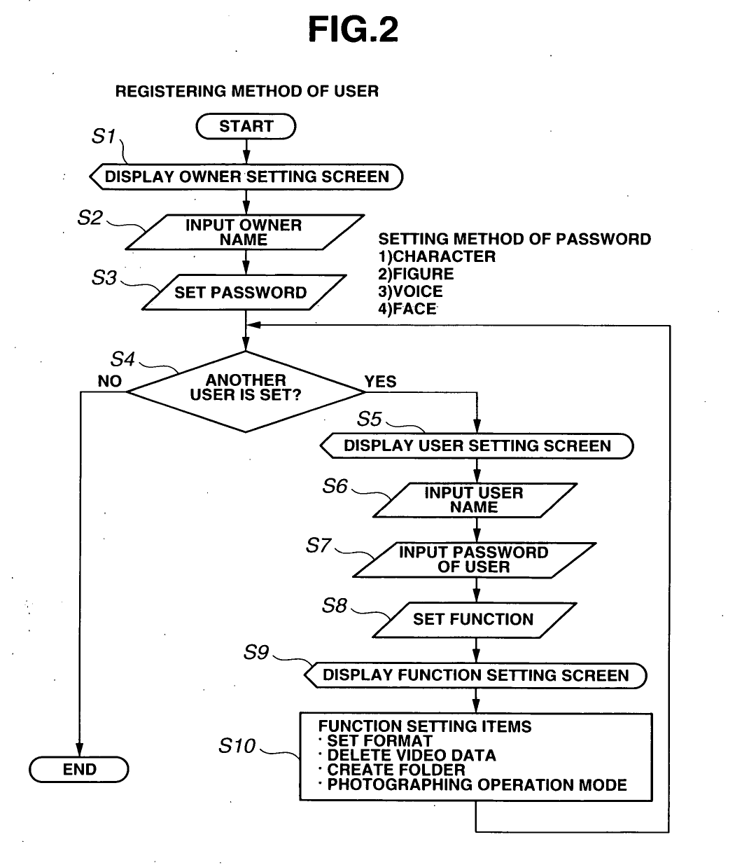

A description is given of the operation in the user registering mode of the control program stored in the microcomputer 16 with reference to FIGS. 2 to 5. First, a description is given of the conceptual definition of the owner of the camera 10 and the user other than the owner. For example, it is assumed that when the family uses the camera 10, a husband as a purchaser of the camera 10 is the owner of the camera 10, and a wife and a child of the owner serving as the family of the owner use the camera 10. Further, it is assumed that the owner of the camera 10 freely uses all the photographing functions provided for the camera 10, and limits the user registration, user addition, user deletion, and photographing function used by each user. Furthermore, it is assumed that the user is permitted in the use of the camera 10 within the range of the photographing function that is set by the owner.

A description is given of the registering and setting of the owner and the user in the user registering mode of the camera 10 with reference to FIG. 2.

The owner turns on a power button arranged to the input button unit 19, and the camera 10 enters an initial starting state. In step S1, the owner operates an operating mode selecting button of the input button unit 19 in the camera 10 in the initial starting state and thus the LCD 18 displays an owner setting screen 31.

In step S1, the microcomputer 16 reads the user registering mode stored in the ROM 16a based on the operating mode selecting button of the input button unit 19, and develops the mode to the RAM 16b. The microcomputer 16 displays the owner setting screen 31 on the LCD 18 via the digital signal processing unit 14 in accordance with the user registering mode.

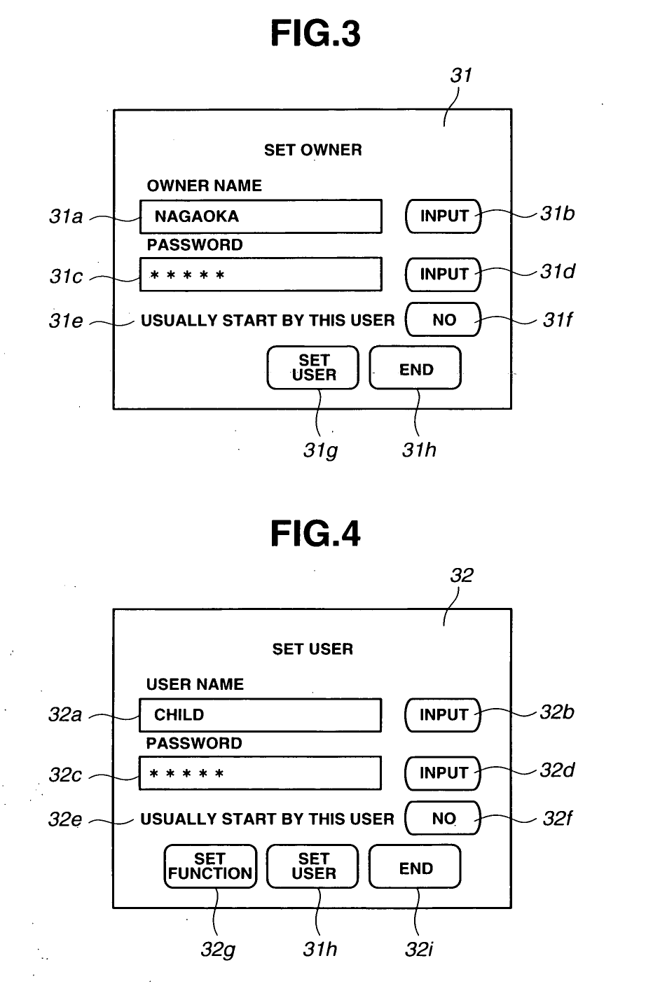

Referring to FIG. 3, the owner setting screen 31 comprises: an owner name input column 31a of the camera 10; a name input button 31b; a password input column 31c of the owner; a password input button 31d; a start message 31e of “usually start by this user”; a YES/NO confirming button 31f; a user setting button 31g which shifts to the setting screen of the user other than the owner; and an end button 31h which ends the owner setting screen 31.

In step S2, the owner inputs the owner name in the owner name input column 31a in accordance with the owner setting screen 31 displayed on the LCD 18. The owner touches the name input button 31b of the owner setting screen 31 displayed on the LCD 18 and thus the owner name is inputted as shown in step S2. The touch panel 20 detects the touching operation at the position of the name input button 31b by the owner. The microcomputer 16 enables the touch panel 20 to display a character input screen (not shown), in place of the owner setting screen 31, based on positional information on the owner touching operation and positional information of the name input button 31b displayed on the LCD 18. The character input screen displays a character list of alphabet, number, and symbol. The owner directly touches and selects his name character from the character list displayed on the LCD 18. Alternatively, a cursor which is movable in the vertical and horizontal directions on the character list is displayed, then, the cursor is moved in the vertical and horizontal directions, and characters of his name are selected. The microcomputer 16 returns the display screen of the LCD 18 to the owner setting screen 31 after ending the character input of the name from the character list displayed on the LCD 18 by the owner, and the characters of the name inputted to the input column 31a are displayed.

Next, in step S3, the owner inputs owner's password in the password input column 31c in accordance with the owner setting screen 31 displayed on the LCD 18. The owner touches the password input button 31d of the owner setting screen 31 displayed on the LCD 18, thereby inputting the password in step S3. The touch panel 20 detects that the owner touches the position of the password input button 31d. The microcomputer 16 enables the LCD 18 to display a password input screen (not shown), in place of the owner setting screen 31, based on positional information of the owner touching operation and positional information of the password input button 31d displayed on the LCD 18. The password includes a character, figure, voice, and face video image.

In the case of setting the registration of the password with characters, similarly to the input of the owner name described in step S2, the LCD 18 displays the character list for inputting the character, and the character selected from the character list is registered as the password.

In the case of setting the registration of the password with the figure, the LCD 18 displays a figure input screen. The touch panel 20 detects a favorite figure which is drawn by the owner on the figure input screen displayed on the LCD 18. Figure data detected by the touch panel 20 is registered as the password.

In the case of setting the registration of the password with the voice, the owner himself speaks a specific word to the microphone 21, a voice signal from the microphone 21 is converted, voice signal data is generated, and the data is inputted as the password.

In the case of setting the registration of the password with the face video image, the owner photographs his own face by the camera 10, and video data of the photographed face is inputted as the password.

The microcomputer 16 returns the display screen on the LCD 18 to the owner setting screen 31 after ending the setting of registration of the password, and displays “*****” data indicating the end of registering setting of the password on the password input column 31c.

After ending the setting for inputting the password in step S3, the owner sets the start message 31e in accordance with the owner setting screen 31 displayed on the LCD 18. In step S4, the owner touches the YES/NO confirming button 31f in response to the start message 31e of “usually start by this user” on the owner setting screen 31 displayed on the LCD 18, thereby setting the start message 31e. The owner touches the YES/NO confirming button 31f of the touch panel 20 and then the microcomputer 16 switches the YES/NO confirming button 31f to “YES” or “NO”, thereby displaying the result. In the case of using the camera 10 only by the owner, or preferentially using the camera 10 by the owner, the YES/NO confirming button 31f is set to “YES”. The camera 10 sets the YES/NO confirming button 31f to “NO” in the case of preferentially using the camera 10 by the user other than the owner.

After ending the input of the owner name, the setting of the password, and the setting of the start message 31e in steps S2 and S3, in step S4, the owner selects and touches, from the owner setting screen 31, any of the user setting button 31g which sets a mode for setting the user other than the owner and the end button 31h which ends the owner setting screen 31.

When the touch panel 20 detects in step S4 that the owner touches the end button 31h, the microcomputer 16 ends the display operation of the owner setting screen 31 displayed on the LCD 18. The owner freely uses all the photographing functions of the camera 10.

After the touch panel 20 detects in step S4 that the owner touches the user setting button 31g, the microcomputer 16 executes a mode for setting of the user other than the owner in steps subsequent to step S5.

The owner touches the user setting button 31g and then, in step S5, a user setting screen 32 is displayed on the LCD 18. Referring to FIG. 4, the user setting screen 32 comprises: a user name input column 32a of the user (owner's family according to the embodiment) other than the owner of the camera 10; a name input button 32b; a password input column 32c of the user; a password input button 32d; a start message 32e of “usually start by this user”; a YES/NO confirming button 32f; a function setting button 32g for setting the photographing function permitted to the user; a user setting button 32h which shifts to the setting screen of another user other than the current user; and an end button 32i which ends the user setting screen 32.

In step S6, the owner sets and registers, in accordance with the user setting screen 32 displayed on the LCD 18, the user name, e.g., his wife name if the user is his wife or his child name if the user is his child, in the user name input column 32a. The input operation of the password in step S6 is the same as that in step S2.

In step S7, the owner sets and registers the password of the user whose name is inputted to the user name input column 32a to the password input column 32c in accordance with the user setting screen 32 displayed on the LCD 18. The password input operation in step S7 is the same as that in step S3.

The setting and registration of the user password end and then the owner selects the YES/NO confirming button 32f in response to “usually start by this user” of the start message 32e on the user setting screen 32. The selection of the YES/NO confirming button 32f is the same as that of the YES/NO confirming button 31f on the owner setting screen 31.

In the case of using the camera 10 only by the user who is set for registration, or preferentially using the camera 10 by the user who is set for registration, the owner sets the YES/NO confirming button 32f to “YES”. In the case of using camera 10 not by the owner or preferentially using camera 10 not by another user, the owner sets the YES/NO confirming button 32f to “NO”.

In step S8, the owner touches the function setting button 32g which sets the photographing function upon using the camera 10 by the user who is set for registration in steps S6 and S7. After the touch panel 20 detects in step S8 that the owner touches the function setting button 32g, in step S9, the microcomputer 16 displays a function setting screen 33 on the LCD 18, in place of the user setting screen 32.

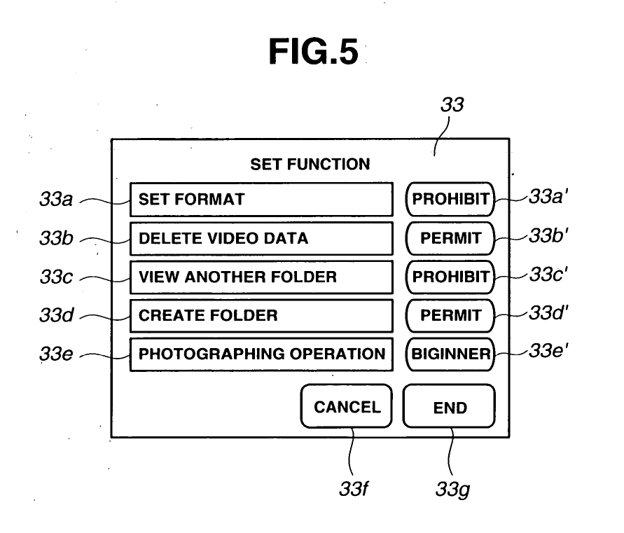

Referring to FIG. 5, the function setting screen 33 comprises: a permission/prohibition selecting button 33a′ of a format setting function 33a; a permission/prohibition selecting button 33b′ of a video data deleting function 33b; a permission/prohibition button 33c′ of another folder viewing function 33c; a permission/prohibition button 33d′ of the folder creating function 33d; a selecting button 33e′ of a beginner photographing mode and a professional photographing mode of a photographing operation mode function 33e; a cancel button 33f which cancels the setting of the format setting function 33a to the photographing operation mode function 33e; and an end button 33g which ends the input of the function setting.

The format setting function 33a sets whether the format setting is permitted or prohibited upon recording the video data photographed by the registered user to the recording medium 17. The deleting function 33b sets whether the deletion of the video data photographed by the registered user and recorded to the recording medium 17 is permitted or prohibited. The folder viewing function 33c sets the permission or prohibition of the registered user to read the video data recorded to the recording medium 17, which is photographed by the owner or another user, from the folder and is viewed. The folder creating function 33d sets the permission or prohibition of the registered user to create a user folder for recording the video data photographed by the registered user to the recording medium 17. The photographing operation mode function 33e selects any of the beginner photographing mode and the professional photographing mode upon using the camera 10 by the registered user.

In the beginner photographing mode, upon a photographer operating the shutter button, first, the automatic setting and photographing operation is performed, including the focusing adjustment of the optical lens by the distance measurement to the subject, the exposure by light measurement of the subject, the adjustment of a shutter speed, and strobe light-emission control. In the professional photographing mode, the operations are individually set and an image is photographed in accordance with the photographer's selection and the subject, including the focusing adjustment, the setting of exposure and shutter speed, and the presence or absence of strobe light-emission.

In step S10, the owner selects and registers the photographing function which is permitted to the user, in accordance with the function setting screen 33 displayed on the LCD 18. With regard to the format setting function 33a, the owner selects the permission or prohibition by operating the permission/prohibition selecting button 33a′. With regard to the deleting function 33b of the video data, the owner selects the permission or prohibition by operating the permission/prohibition selecting button 33b′. With regard to the folder viewing function 33c, the owner selects the permission or prohibition by operating the permission/prohibition button 33c′. With regard to the folder creating function 33d, the owner selects the permission or prohibition by operating the permission/prohibition button 33d′. With regard to the photographing operation mode function 33e, the owner selects the beginner photographing operation or professional photographing operation by operating the selecting button 33e′.

Referring to FIG. 5, the function setting screen 33 is an example in which the child is permitted as the user. The format setting function 33a is set to the prohibition, the deleting function 33b is set to the permission regarding the video data photographed by the user himself, the folder viewing function 33c is set to the prohibition regarding the video data of another user, the folder creating function 33d is set to the permission regarding the video data photographed by the user himself, and the photographing operation mode function 33e is set to the beginner photographing mode.

The owner ends the function setting in accordance with the function setting screen 33 in step S10. Then, the owner operates the end button 33g. By operating the end button 33g, the microcomputer 16 returns to step S4 whereupon the user setting screen 32 is displayed again on the LCD 18 and it is determined whether or not the setting of another user continues.

The photographing function set by the function setting screen 33 is not limited to the format setting function 33a to the photographing operation mode function 33e, and may be applied to another operating function, other than the above-mentioned functions. The owner of the camera 10 freely uses all the photographing functions, and further freely views the folder of the user other than the owner and freely deletes the video data. However, the photographing function used by the owner is limited, at least the deletion and the viewing of the video data photographed by the user other than the owner may be prevented.

As mentioned above, the camera 10 comprises: a user setting unit for setting the registration of the owner in steps S2 and S3 and of a plurality of users in steps S6 and S7 and for setting the registration of the password serving as identification information for identifying the user including the owner; and a using photographing-function setting unit for setting and registering the photographing function which permits the user to the user registered in steps S9 and S10.

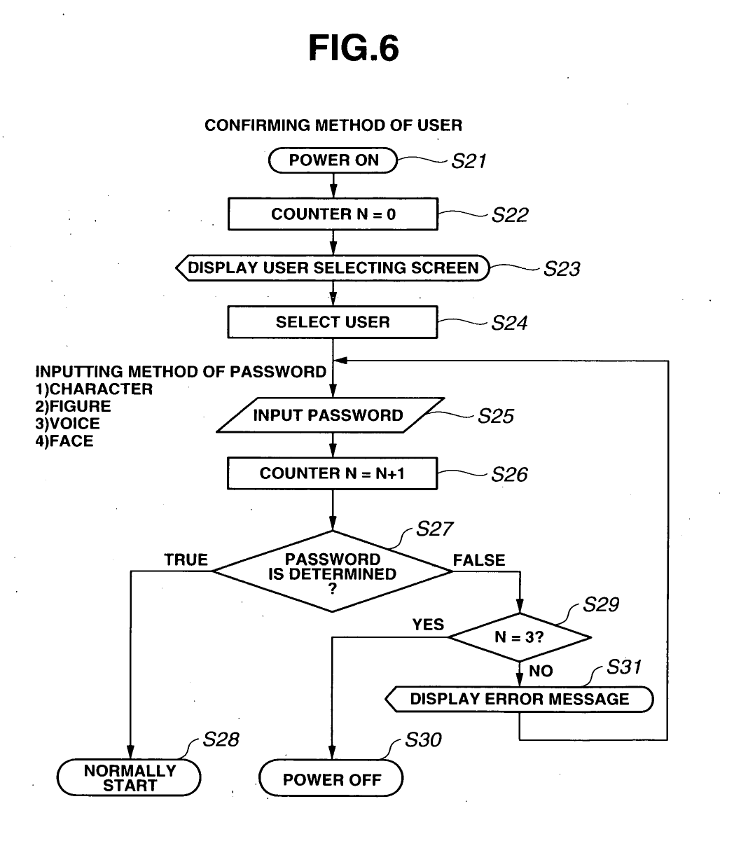

Next, a description is given of a mode for confirming the user in the photographing operation of the camera 10 with reference to FIGS. 6 to 16.

In step S21, the user turns on the power button included in the input button unit 19 in the camera 10, and sets the starting state for photographing operation. The camera 10 enters the starting state and then, in step S22, the microcomputer 6 sets the number N of counting of a counter to zero (N=0).

In step S23, the microcomputer 16 reads the mode for confirming the user from the control program stored in the ROM 16a, and displays a user selecting screen 34 on the LCD 18.

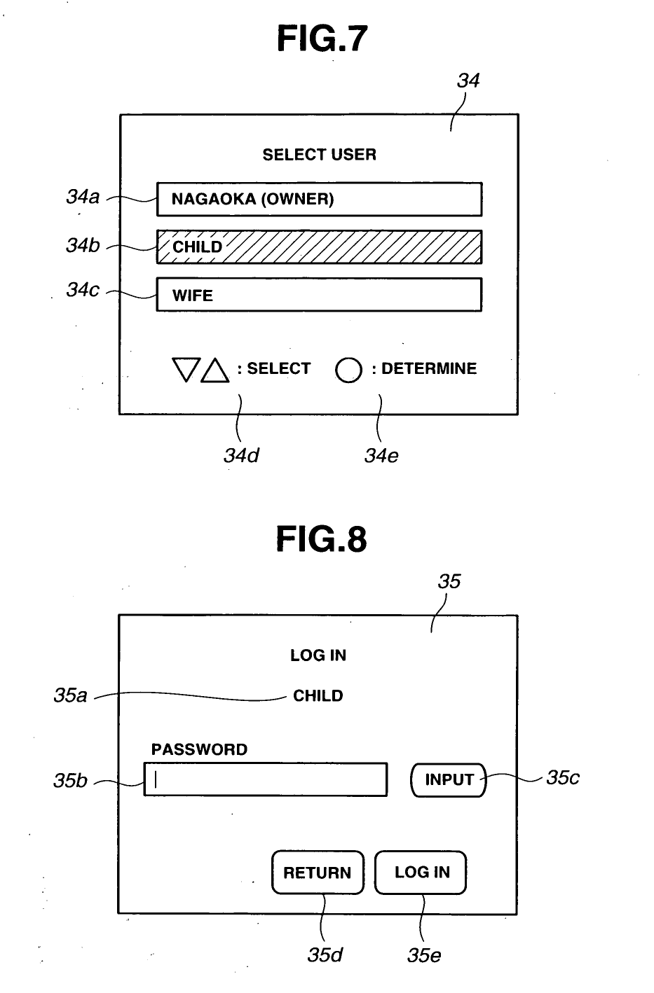

Referring to FIG. 7, the user selecting screen 34 displays the list of users including the owner which is registered and is set to the camera 10.

The user selecting screen 34 displays, e.g., an owner name 34a, a child name 34b, and a wife name 34c which are registered by inputting the names of the owner and the user as mentioned above with reference to FIG. 2. Further, the user selecting screen 34 comprises a selecting button 34d with up and down arrows which vertically operates a cursor for selecting the user from the user names 34a to 34c, and a determining button 34e which determines the user selected by the selecting button 34d.

Referring to FIG. 7, in step S24, the user of the camera 10 moves the cursor to the user name by using the selecting button 34d, and selects the user by operating the determining button 34e. For example, referring to FIG. 7, when the user is the child, the cursor is moved to the child name 34b by using the selecting button 34d, and the determining button 34e is operated.

When the YES/NO confirming button 31f of the start message 31e is set to “YES” on the owner setting screen 31 as mentioned above with reference to FIG. 3 or when the YES/NO confirming button 32f of the start message 32e is selected “YES” on the user setting screen 32 as mentioned above with reference to FIG. 4, the user selecting screen 34 is set so that the cursor is positioned to the user of “YES” of the YES/NO confirming button 31f or the YES/NO confirming button 32f. That is, in the selection and setting of the YES/NO confirming button 31f and the YES/NO confirming button 32f of the start message 31e and the start message 32e, the start operation of the preferential user of the camera 10 is fast executed by setting the user who frequently uses the camera 10 or preferentially uses the camera 10.

After ending the selection of the user of the camera 10 in step S24, in step S25, the microcomputer 16 displays a password log-in screen 35 for inputting the user password on the LCD 18.

In steps S3 and S7 as mentioned above with reference to FIG. 2, on the password log-in screen 35, the password is inputted with the character, figure, voice, or face video image which is used upon setting the password of the owner and the user other than the owner. Herein, a description is given of an example of the password comprising the character, and the input and comparison of the password comprising the figure, voice, or face video image will be described later.

In step S25, the password log-in screen 35 is displayed to input the password comprising the character on the LCD 18. Referring to FIG. 8, the password log-in screen 35 comprises: a user name display 35a for displaying the user name; a user character password input column 35b; a password input button 35c; a return button 35d which returns the screen from the password log-in screen 35 of the character to the user selecting screen 34; and a log-in button 35e for log-in of the input password comprising the character.

The user operates the password input button 35c of the password log-in screen 35. Although not shown, the microcomputer 16 displays the list of characters, in place of the password log-in screen 35, similarly to steps S3 and S7. The user selects and inputs the characters of the password which is registered from the list of characters. When the characters of the password are inputted, the microcomputer 16 returns the display screen of the LCD 18 to the password log-in screen 35 from the list of characters.

Next, in step S26, the microcomputer 16 adds one to the number N of counting of the counter (N=N+1), and the number N of the password input times is counted.

Subsequently, in step S27, the microcomputer 16 determines the password by comparing the user name selected in step S24 and the user password inputted in step S25 with the user name and the password registered in advance. When the microcomputer 16 determines in step S27 that the user name and the password are correct, in step S28, the microcomputer 16 starts the camera 10 which is operated for photographing operation based on the photographing function permitted to the user which is set in advance.

When the microcomputer 16 determines in step S27 that the password inputted in step S25 is not correct, in step S29, the microcomputer 16 determines whether or not the number N of input times of the password counted in step S26 is 3 (N=3). When the microcomputer 16 determines in step S29 that the number N of input times of the password is 3, in step S30, the microcomputer 16 disconnects the power switch of the camera 10 so as to prevent the photographing operation. When the microcomputer 16 determines in step S29 that the number N of input times of the password is exceeding 3, the microcomputer 16 displays an error message so that the correct password is inputted to the LCD 18, and the processing returns to step S25 whereupon the password is inputted.

In the user confirming mode, regarding the photographing function of the camera 10 for every user and the user name and password including the owner of the camera 10 which are registered in advance, it is determined whether or not the user is the user to whom the use of the camera 10 is permitted by comparing the user name inputted upon using the camera 10 with the user password. Further, a user determining unit is provided to enable the photographing operation using the photographing function set to the use-permitted user.

Thus, in the camera 10, the identification of the owner and the user of the camera 10 is possible. Further, it is possible to prevent the erroneous deletion and free viewing of the video data which is photographed by another user.

In the description of the password input in step S25, the user password comprises the character. As mentioned above, in the camera 10, the password can be set by using the figure, voice, and face video image, in addition to the character. Then, a description is given of the password input in step S25 upon setting the password comprising the figure, voice, and face video image, other than the character. The input method of the password can be applied to the password input in steps S2 and S7 as mentioned above.

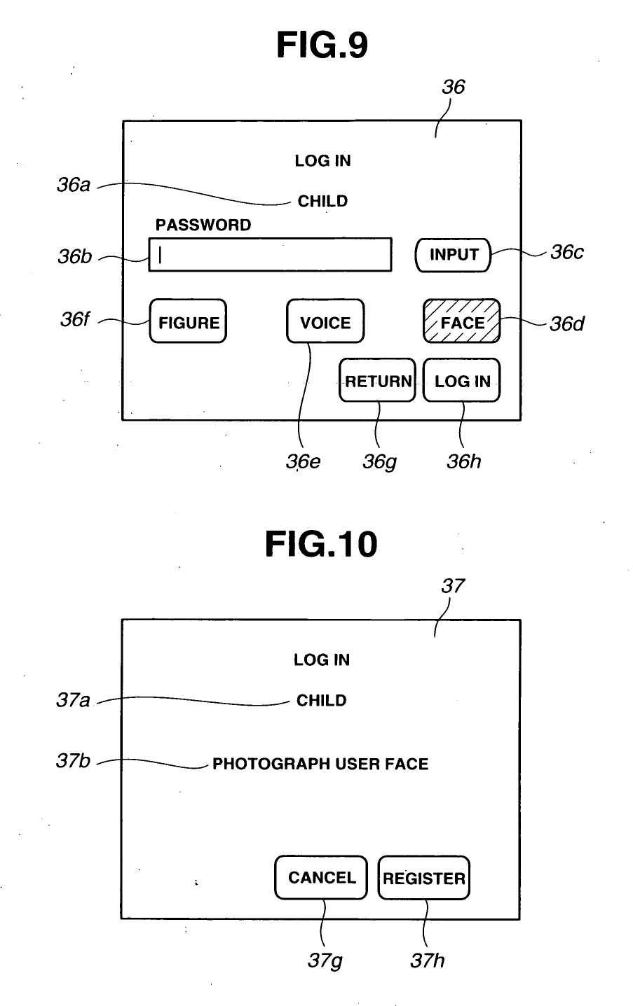

In step S24, the user of the camera 10 is selected. In step S25, the microcomputer 16 displays a password log-in screen 36 shown in FIG. 9 on the LCD 18. The password log-in screen 36 comprises: a user name display 36a which displays the user name; a user character password input column 36b; a password input button 36c; a face video password selecting button 36d; a voice password selecting button 36e; a figure password selecting button 36f; a return button 36g; and a log-in button 36h.

In the case of the password comprising the character, the user touches the user character password input column 36b and the password input button 36c on the password log-in screen 36, then, displays the character password input screen on the LCD 18 as mentioned above, and inputs the character password.

In the case of the password comprising the face video image, the user operates the face video password selecting button 36d and the password input button 36c which are shown by the shade in FIG. 9 and thus displays a face photographing screen 37 on the LCD 18 as shown in FIG. 10. The face photographing screen 37 comprises: a user name display 37a; a message 37b of “Photograph user face”; a cancel button 37c; and a registering button 37d.

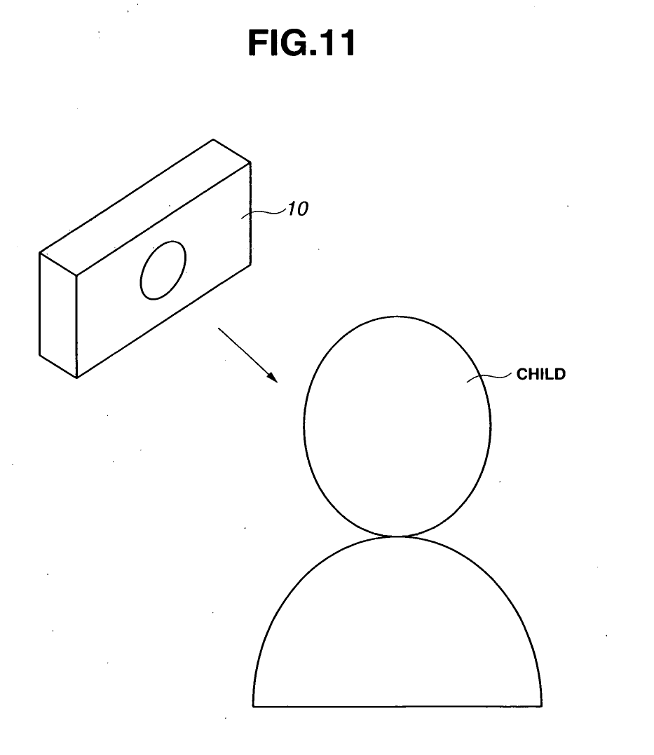

Referring to FIG. 11, the user photographs his face by directing the camera 10 to his face in accordance with the face photographing screen 37. After photographing the user's face, the user touches the registering button 37d, thereby capturing video data of the photographed user's face. Further, the display of the LCD 18 is returned to the password log-in screen 36.

When the user erroneously selects and displays the face photographing screen 37 on the LCD 18, he touches the cancel button 37c and returns the display operation on the LCD 18 to the password log-in screen 36.

On the password log-in screen 36, the user operates the log-in button 36h so as to compare the face video image photographed on the face photographing screen 37 with the user face video image which is set in advance. The microcomputer 16 confirms the user password by touching the log-in button 36h. If the input password matches the password of the face video image, the microcomputer 16 enables the photographing operation using the photographing function permitted to the user.

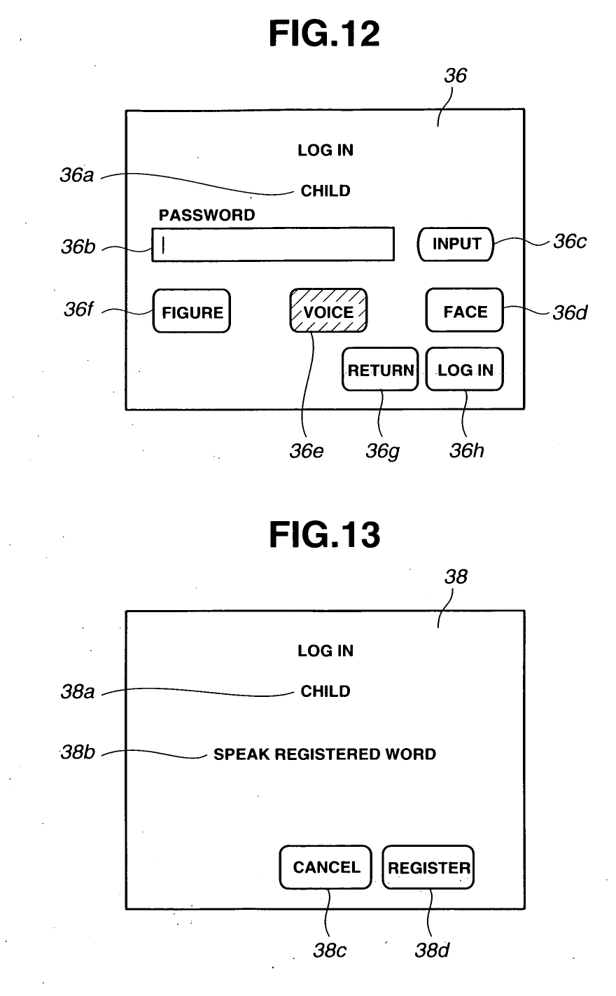

In the case of the password comprising the voice, the user touches the voice password selecting button 36e which is shown by the shade in FIG. 12 and the password input button 36c, and displays a voice input screen 38 on the LCD 18 as shown in FIG. 13. The voice input screen 38 comprises: a user name display 38a; a message 38b of “speak registered word”; a cancel button 38c; and a registering button 38d.

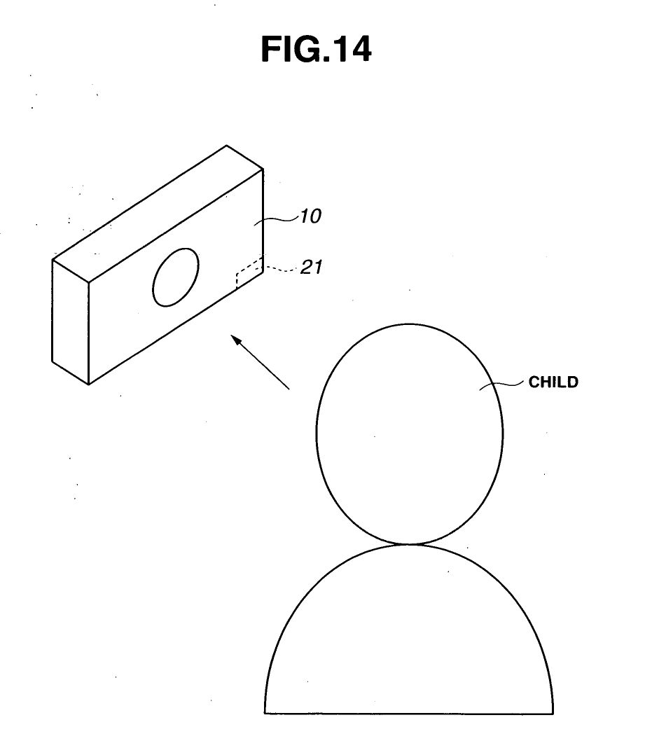

Referring to FIG. 14, the user generates, to the microphone 21 of the camera 10, the voice of a word that is set as a voice password in advance. The generated word is converted into a voice signal by the microphone 21. After generating the voice of the user word, the user touches the registering button 38d and then the voice signal is captured. Then, the display operation on the LCD 18 is returned to the password log-in screen 36. Further, when the user erroneously selects and displays the voice input screen 38, he touches the cancel button 38c and the display operation on the LCD 18 is returned to the password log-in screen 36.

On the password log-in screen 36, the user touches the log-in button 36h so as to compare the voice signal captured on the voice input screen 38 with the voice signal of the user which is set in advance. The microcomputer 16 confirms the password of the user by the user touching the log-in button 36h. If the input password matches the password comprising the voice, the microcomputer 16 enables the photographing operation using the predetermined function permitted to the user.

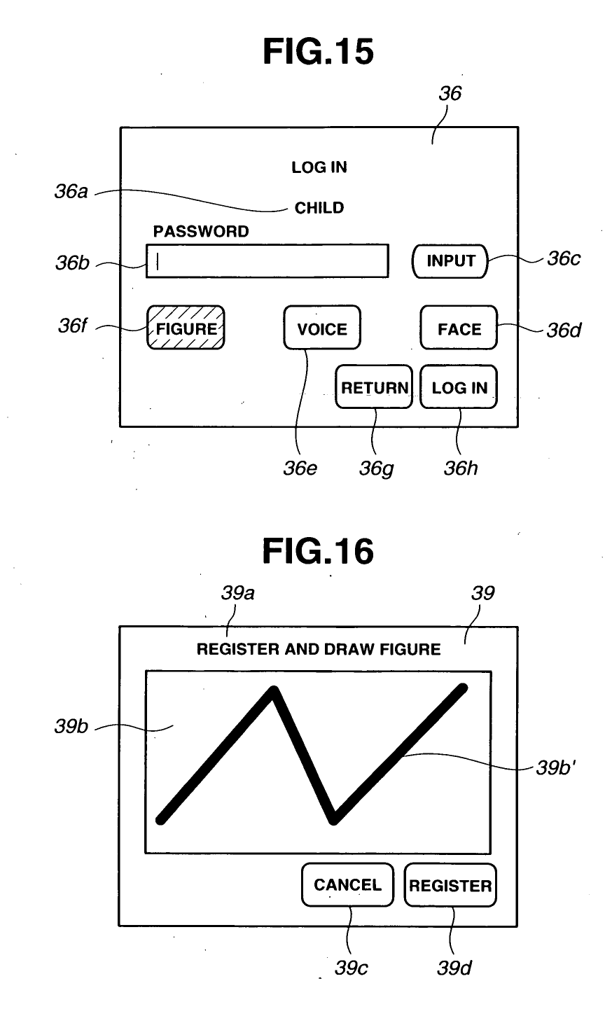

In the case of the password comprising the figure, the user touches the figure password selecting button 36f which are shown by the shade in FIG. 15 and the password input button 36c, and displays a figure input screen 39 on the LCD 18 as shown in FIG. 16. The figure input screen 39 comprises: a message 39a of “Draw registered figure”; a figure drawing area 39b; a cancel button 39c; and a registering button 39d. Although not shown, the figure input screen 39 may display the user name.

Referring to FIG. 16, the user draws a FIG. 39b′ which is set as a figure password in advance in the figure drawing area 39b in accordance with the figure input screen 39 by using the finger or an elongate stick with a circular tip. The drawn FIG. 39b′ is converted into a figure signal. After drawing the figure, the user touches the registering button 39d, and then the figure signal is captured. Then, the display of the LCD 18 is returned to the password log-in screen 36. The user erroneously selects and displays the figure input screen 39 on the LCD 18, then, touches the cancel button 39c, and returns the display of the LCD 18 to the password log-in screen 36.

On the password log-in screen 36, the user touches the log-in button 36h so as to compare the figure signal captured on the figure input screen 39 with the figure signal of the user which is set in advance. The microcomputer 16 confirms the user password by the user touching the log-in button 36h. When the password matches the registered password comprising the figure, the photographing using the function of the photographing operation permitted to the user can be executed.

As mentioned above, the camera 10 according to the embodiment of the present invention can set a plurality of types of passwords including the character, figure, voice, and video face so as to confirm the user including the owner. Further, the user can be confirmed more strictly by combining the passwords, e.g., the character and the figure, the character and the voice, and the character and face video image. Therefore, the camera 10 does not easily enable the change or deletion of the user registration including the owner.

The camera 10 is not operated upon losing the password of the owner and the password of the user other than the owner described with reference to FIGS. 2 to 4 or by losing the password set to the camera 10 due to any reason.

Meanwhile, the camera 10 comprises a CD-ROM having a program for writing and recording the video data recorded to the recording medium 17 to another recording medium such as a CD or DVD by using a personal computer.

Then, the camera 10 further comprises a user resetting program for resetting the camera 10 to the registering state of the owner and the owner other than the owner in the initial setting state, in addition to the program for writing and recording the video data of the CD-ROM to a CD or DVD. The user resetting program arranged to the CD-ROM returns the camera 10 to the state for resetting and registering the owner and the user via the personal computer when the password of the camera 10 is lost or the password set to the camera 10 is lost due to any reason.

Having described the preferred embodiment of the invention referring to the accompanying drawings, it should be understood that the present invention is not limited to the precise embodiment and various changes and modifications thereof could be made by one skilled in the art without departing from the spirit or scope of the invention as defined in the appended claims.

1. A digital camera comprising:
a photographing and display unit for performing digital signal processing on a photographing image signal that is generated by photographing a subject image, to generate a digital video signal, and for displaying an image based on the digital video signal;
a user setting unit for setting identification information for identifying a plurality of users including an owner of the photographing and display unit;
a using photographing-function setting unit for setting a photographing function of the photographing and display unit that permits the use by every user to set by the user setting unit; and
a user determining unit for determining the user based on the identification information of the user set by the user setting unit and for enabling photographing the image by using the photographing function set to the using photographing-function setting unit.

2. A digital camera according to claim 1, wherein the user setting unit uses a password including a character, a figure, voice, and face video image, in addition to a user name, as the identification information of the user including the owner.

3. A digital camera according to claim 1, wherein the user setting unit sets the owner and the user other than the owner to be identified.

4. A digital camera according to claim 1, wherein the using photographing-function setting unit sets the photographing function used in the photographing operation of the photographing and display unit of the owner to be different from that of the user other than the owner.

5. A digital camera according to claim 1, wherein the user determining unit preferentially determines the user with the highest using frequency of the photographing and display unit among a plurality of users set by the user determining unit.

6. A digital camera comprising:
a photographing and display unit for performing digital signal processing on a photographing image signal that is generated by photographing a subject image, to generate a digital video signal, and for displaying an image based on the digital video signal;
a user setting unit for setting identification information for identifying a plurality of users including an owner of the photographing and display unit;
a using photographing-function setting unit for setting a photographing function of the photographing and display unit that permits the use by every user set by the user setting unit;
a user determining unit for determining the user based on the identification information of the user set by the user setting unit and for enabling photographing the image by using the photographing function set to the using photographing-function setting unit; and
a correcting unit for performing the correction including change, deletion, and addition of the photographing function of the photographing and display unit that is used by the user other than the owner set by the user setting unit and the user other than the owner set by the using photographing-function setting unit.

7. A digital camera comprising:
a photographing and display unit for performing digital signal processing on a photographing image signal that is generated by photographing a subject image, to generate a digital video signal, and for displaying an image based on the digital video signal;
a user setting unit for setting identification information for identifying a plurality of users including an owner of the photographing and display unit;
a using photographing-function setting unit for setting a photographing function of the photographing and display unit that permits the use by every user set by the user setting unit;
a user determining unit for determining the user based on the identification information of the user set by the user setting unit and for enabling photographing the image by using the photographing function set to the using photographing-function setting unit; and
a restoring unit for restoring the state of the digital camera so as to use the photographing and display unit when the identification information of the user including the owner set to the user setting unit is lost and the photographing and display unit is disabled from using.

8. A digital camera according to claim 7, wherein the restoring unit comprising:
a recording medium having a user resetting program for returning the user setting unit; and
an external device connected to the photographing and display unit, wherein
the user resetting program recorded to the recording medium for restoring via the external device the user setting unit so as to be able to register and set the user including the owner.
